(19) United States
(12) Patent Application Publication
(10) Pub. No.: US 2022/0180160 A1
(43) Pub. Date: Jun. 9, 2022

(54) OUTLIER DETECTION DEVICE, OUTLIER DETECTION METHOD, AND OUTLIER DETECTION PROGRAM

(71) Applicant: TDK CORPORATION, Tokyo (JP)

(72) Inventor: Kazuki NAKADA, Tokyo (JP)

(73) Assignee: TDK CORPORATION, Tokyo (JP)

(21) Appl. No.: 17/441,761

(22) PCT Filed: Mar. 27, 2019
(86) PCT No.: PCT/JP2019/013320

§ 371 Date: Sep. 22, 2021

(51) Int. Cl. G06N 3/063; G06N 3/08; G06N 3/04; G06K 9/62

(52) U.S. Cl. CPC G06N 3/063; G06K 9/6284; G06N 3/04; G06N 3/08

(57) ABSTRACT

An outlier detection device includes a reservoir computer having an input layer, a reservoir main unit including neurons connected by synapses, and a read-out configured to calculate and output an inner product of a weight vector and an activity value vector, each element of which is an activity value output from each of neurons based on an input to the input layer, a learning unit configured to acquire an observed signal, calculate an error between the inner product and the observed signal, and update the weight vector using a value obtained by applying an adaptive filter to the error, a norm calculation unit configured to sequentially calculate a norm of the weight vector updated by the learning unit, and a determination unit configured to determine whether an outlier is included in the observed signal based on at least one of the norms calculated by the norm calculation unit.

### TECHNICAL FIELD

The present invention relates to an outlier detection device, an outlier detection method, and an outlier detection program in time-domain.

### BACKGROUND ART

Currently, a technology of detecting outliers of time-series signals has become increasingly important in various fields. For example, Patent Document 1 discloses an anomaly detection model construction device that includes a data acquisition unit, a characteristic determination unit, a data identification reception unit, and a simulation execution unit, an anomaly detection model construction method, and a program.

The data acquisition unit receives time-series sampling data as a data set. The characteristic determination unit is configured to determine whether a data set acquired by the data acquisition unit has one or more characteristics selected by a user among a plurality of predetermined characteristics. The data identification reception unit receives identification of normal data or anomaly data by the user in the data set. The simulation execution unit executes an anomaly detection simulation on the data set on the basis of an algorithm associated with any one characteristic which the data set is determined to have among any one or more characteristics by the characteristic determination unit, and evaluates the algorithm when normal data or abnormal data for which the data identification reception unit has received the identification is a correct answer.

### CITATION LIST

### Patent Literature

### [Patent Literature 1]

Japanese Patent No. 6315528

### SUMMARY OF INVENTION

### Technical Problem

However, the anomaly detection model construction device, the anomaly detection model construction method, and the program described above are technologies to detect an outlier included in the observed signal by executing pattern matching between the observed signal and time-series signals which are teacher data in a time region or a frequency region. Therefore, since the anomaly detection model construction device, the anomaly detection model construction method, and the program described above have a complicated algorithm, the hardware configurations thereof for realizing the algorithm are complicated, and it may be difficult to realize them as hardware.

Therefore, an object of the present invention is to provide an outlier detection device, an outlier detection method, and an outlier detection program in time-domain, which can be easily realized as hardware.

### Solution to Problem

According to one aspect of the present invention, an outlier detection device includes a reservoir computer having an input layer, a reservoir main unit including a plurality of neurons connected to each other by synapses, and a read-out that is configured to calculate and output an inner product of a weight vector and an activity value vector, each element of which is an activity value output from each of the plurality of neurons on a basis of an input to the input layer, a learning unit configured to acquire an observed signal, calculate an error between the inner product and the observed signal, and update the weight vector using a value obtained by applying an adaptive filter to the error, a norm calculation unit configured to sequentially calculate a norm of the weight vector updated by the learning unit, and a determination unit configured to determine whether an outlier is included in the observed signal on the basis of at least one of the norms calculated by the norm calculation unit.

In addition, in one aspect of the present invention, the determination unit is configured to determine whether the norm sequentially calculated by the norm calculation unit exceeds a predetermined threshold value, and the norm calculation unit is configured to subtract a predetermined value from the sequentially calculated norm when it is determined that the norm sequentially calculated by the norm calculation unit exceeds a predetermined threshold value.

Moreover, in one aspect of the present invention, the learning unit is configured to use a systolic array when the adaptive filter is applied to calculate an update value in accordance with the error.

In addition, according to another aspect of the present invention, an outlier detection method includes a reservoir computing step of outputting an inner product of a weight vector and an activity value vector, each element of which is an activity value output by each of a plurality of neurons connected to each other by synapses on a basis of an input to an input layer; a learning step of acquiring an observed signal, calculating an error between the inner product and the observed signal, and updating the weight vector using a value obtained by applying an adaptive filter to the error, a norm calculation step of sequentially calculating a norm of the weight vector updated in the learning step, and a determination step of determining whether an outlier is included in the observed signal on the basis of at least one of the norms calculated in the norm calculation step.

Moreover, according to still another aspect of the present invention, an outlier detection program causes a computer to execute a reservoir computing function of having an input layer, a reservoir main unit including a plurality of neurons connected to each other by synapses, and a read-out for outputting an inner product of a weight vector and an activity value vector, each element of which is an activity value output from each of the plurality of neurons on a basis of an input to the input layer, a learning function of acquiring an observed signal, calculating an error between the inner product and the observed signal, and updating the weight vector using a value obtained by applying an adaptive filter to the error, a norm calculation function of sequentially calculating a norm of the weight vector updated in the learning function, and a determination function of determining whether an outlier is included in the observed signal on the basis of at least one of the norms calculated in the norm calculation function.

### Advantageous Effects of Invention

According to the outlier detection device, the outlier detection method, and the outlier detection program described above, it is possible to provide an outlier detection device, an outlier detection method, and an outlier detection program that can be easily realized as hardware.

### BRIEF DESCRIPTION OF DRAWINGS

FIG. 1 is a diagram which shows an example of a partial configuration of an outlier detection device according to an embodiment.

FIG. 2 is a diagram which shows an example of norms of an output, an observed signal, and a weight vector of a reservoir computer according to the embodiment.

FIG. 3 is a diagram which shows an example of the norms of an output, an observed signal, and a weight vector of a reservoir computer according to the embodiment.

FIG. 4 is a diagram for describing an example of processing executed by the outlier detection device according to the embodiment.

### DESCRIPTION OF EMBODIMENTS

### Embodiment

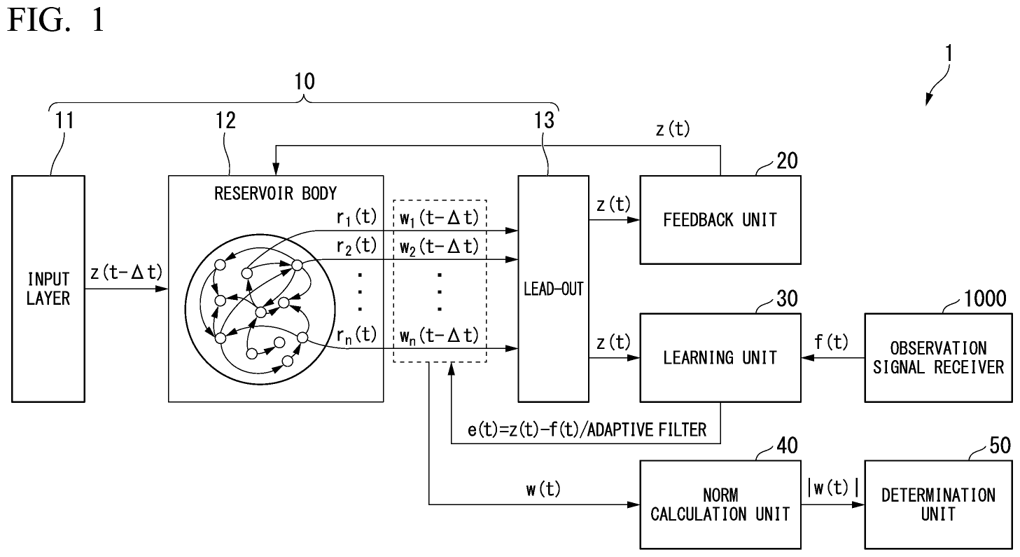

An example of the configuration of a product-sum operator according to an embodiment will be described with reference to FIGS. 1 to 3. FIG. 1 is a diagram which shows an example of a partial configuration of an outlier detection device according to the embodiment.

As shown in FIG. 1, an outlier detection device 1 includes a reservoir computer 10, a feedback unit 20, a learning unit 30, a norm calculation unit 40, and a determination unit 50.

The reservoir computer 10 is a recurrent neural network (RNN) that executes First Order Reduced and Controlled Error (FORCE) learning, and includes an input layer 11, a reservoir main unit 12, and a read-out 13. In the following description, a case in which a weight vector w(t−Δt) of each arrow connecting a reservoir main unit 12 and a read-out 13 is updated to a weight vector w(t) at a time t will be described as an example.

The input layer 11 outputs the inner product z(t−Δt) of a weight vector represented by the following equation (1) and an activity value vector represented by the following equation (2) to the reservoir main unit 12. In addition, this inner product z(t−Δt) is represented by the following equation (3). Here, the time Δt is a time required to update the weight vector of each arrow connecting the reservoir main unit 12 and the read-out 13 one time.

$$\begin{matrix}[ Math . 1 ] & \\ w ( t - 2 Δ t ) = ( {w}_{1} ( t - 2 Δ t ) , {w}_{2} ( t - 2 Δ t ) , ⋯ , {w}_{n} ( t - 2 Δ t ) ) & ( 1 ) \\ [ Math . 2 ] & \\ r ( t - Δ t ) = ( {r}_{1} ( t - Δ t ) , {r}_{2} ( t - Δ t ) , ⋯ , {r}_{n} ( t - Δ t ) ) & ( 2 ) \\ [ Math . 3 ] & \\ z ( t - Δ t ) = {w}^{T} ( t - 2 Δ t ) r ( t - Δ t ) & ( 3 )\end{matrix}$$

The reservoir main unit 12 includes a plurality of neurons connected to each other by synapses. The neurons are indicated by white circles in FIG. 1. The synapses are indicated by arrows connecting these white circles and are weighted. In addition, neurons to which synapses are connected do not change even if the weight vector is updated. In addition, the weight set in the synapses does not change even when the weight vector is updated.

Also, the reservoir main unit 12 includes arrows connecting at least one neuron and the read-out 13. The arrows are indicated by arrows connecting a neuron and the read-out 13 in FIG. 1, and a weight w₁(t), a weight w₂(t), . . . , and a weight wₙ(t) shown in FIG. 1 are set therein. These weights are updated at intervals of the time Δt by the learning unit 30. Moreover, neurons connected to the read-out 13 by the arrows output an activity value r₁(t), an activity value r₂(t), . . . , and an activity value rₙ(t) shown in FIG. 1 on the basis of, for example, the inner product z(t−Δt) input by the input layer 11.

The read-out 13 calculates an inner product z(t) of a weight vector represented by the following equation (4) and an activity value vector represented by the following equation (5), and outputs the calculated inner product to the feedback unit 20 and the learning unit 30. Each element of the activity value vector represented by Equation (5) is the activity value r₁(t), the activity value r₂(t), . . . , or an activity value rₙ(t) that have been output by a neuron connected to the read-out 13 by an arrow. Moreover, this inner product z(t) is represented by the following equation (6).

$$\begin{matrix}[ Math . 4 ] & \\ w ( t - Δ t ) = ( {w}_{1} ( t - Δ t ) , {w}_{2} ( t - Δ t ) , ⋯ , {w}_{n} ( t - Δ t ) ) & ( 4 ) \\ [ Math . 5 ] & \\ r ( t ) = ( {r}_{1} ( t ) , {r}_{2} ( t ) , ⋯ , {r}_{n} ( t ) ) & ( 5 ) \\ [ Math . 6 ] & \\ z ( t ) = {w}^{T} ( t - Δ t ) r ( t ) & ( 6 )\end{matrix}$$

The feedback unit 20 feeds back the inner product z(t) acquired from the read-out 13 to the reservoir main unit 12.

The learning unit 30 acquires the observed signal f(t) from the observed signal receiver 100, and calculates an error between the inner product z(t) represented by equation (6) described above and the observed signal f(t). This error is represented by the following equation (7). Moreover, the observed signal f(t) herein is an example of a time-series signal, and is, for example, a signal for driving a motor that operates a robot arm, and an electrocardiographic waveform of a human heart.

$$[ Math 7 ]$$

$$e ( t ) = z ( t ) - f ( t ) \qquad ( 7 )$$

Then, the learning unit 30 updates the weight vector represented by equation (4) described above to the weight vector represented by the following equation (8) by using an update value calculated by the adaptive filter in accordance with an error represented by equation (7) described above. Moreover, the learning unit 30 applies an adaptive filter to the error by using, for example, a systolic array.

$$[ Math 8 ]$$

$$w ( t ) = ( {w}_{1} ( t ) , {w}_{2} ( t ) , ⋯ , {w}_{n} ( t ) ) \qquad ( 8 )$$

The norm calculation unit 40 sequentially calculates the norm of a weight vector updated by the learning unit 30. For example, the norm calculation unit 40 calculates the norm of a weight vector updated by the learning unit 30, that is, a weight vector represented by equation (8) described above. This norm is represented by the following equation (9).

$$[ Math 9 ]$$

$$\vert w ( t ) \vert = {\{ {{w}_{1} ( t )}^{2} + {{w}_{2} ( t )}^{2} + ⋯ + {{w}_{n} ( t )}^{2} \}}^{1 \text{/} 2} \qquad ( 9 )$$

The outlier detection device 1 updates a weight vector having, as elements thereof, weights set in arrows connecting neurons included in the reservoir main unit 12 and the read-out 13, calculates the norm of an updated weight vector, and generates time-series data of the norm by repeatedly executing the processing described above at intervals of the time Δt.

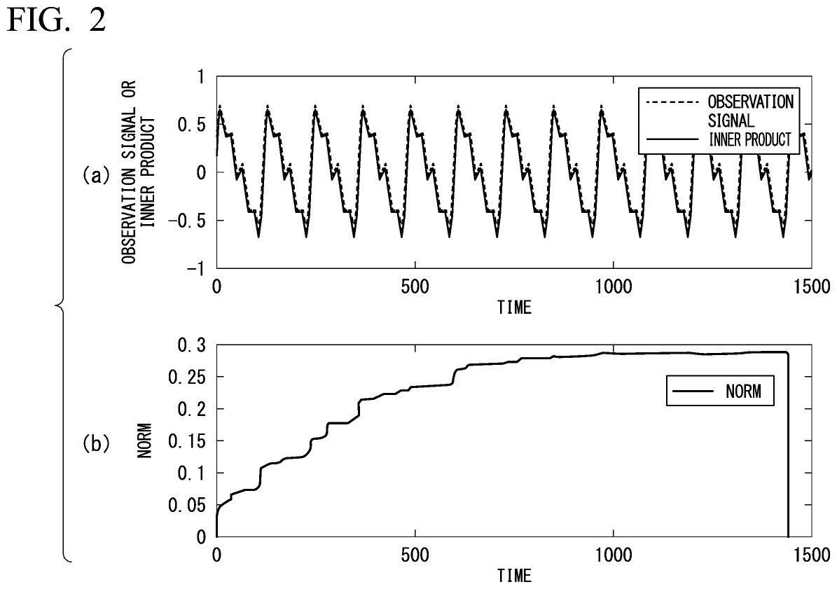

FIG. 2 is a diagram which shows an example of norms of an output, an observed signal, and a weight vector of the reservoir computer according to the embodiment. FIG. 2(a) shows the inner product z(t) output by the read-out 13 using a solid line, and shows a Fourier waveform, which is an example of the observed signal f(t) acquired by the learning unit 30 from the observed signal receiver 1000, using a broken line. This Fourier waveform is an example of a waveform that constantly changes periodically. In addition, the observed signal receiver 1000 acquires, for example, the observed signal f(t) from a sensor installed outside the outlier detection device 1. FIG. 2(b) shows a norm of a weight vector calculated at each time.

As shown in FIG. 2, the norm of the weight vector increases as the outlier detection device 1 acquires the observed signal f(t) and continues to update the weight vector. That is, the norm of the weight vector increases as learning of the reservoir computer 10 progresses.

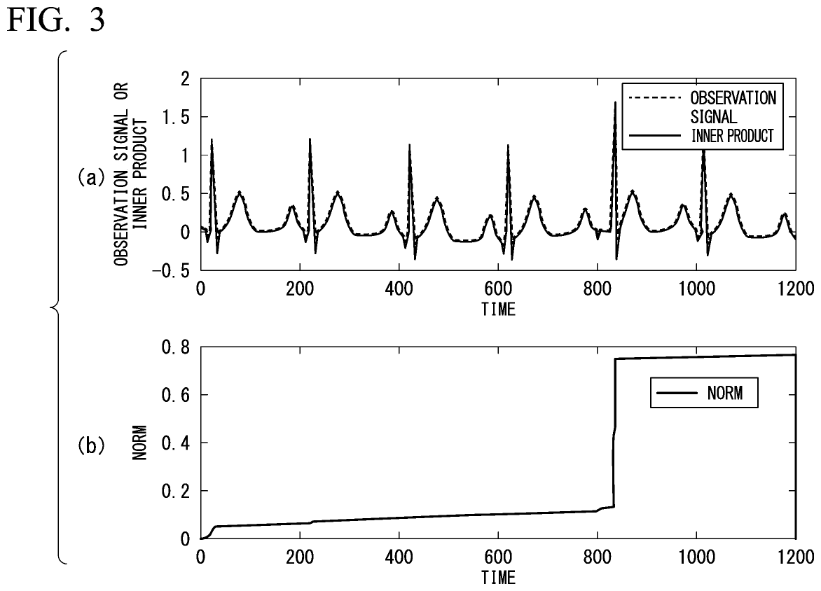

FIG. 3 is a diagram which shows an example of the norms of an output, an observed signal, and a weight vector of the reservoir computer according to the embodiment. FIG. 3(a) shows the inner product z(t) output by the read-out 13 using a solid line, and shows an electrocardiographic waveform of a human, which is an example of the observed signal f(t) acquired by the learning unit 30 from the observed signal receiver 1000, using a broken line. Although this electrocardiographic waveform changes periodically, it is a waveform containing constant fluctuations, and obtained by adding an artifact to a fifth R wave among R waves that have a maximum value in one cycle. This artifact is an example of an outlier, and is a value determined to be independent of the electrocardiographic waveform. Moreover, the outlier herein includes not only a value that greatly deviates from a normal value of the observed signal f(t) but also an anomalous value that occurs due to an error in measurement or the like. FIG. 3(b) shows the norm of a weight vector calculated at each time.

As shown in FIG. 3 (b), the norm of a weight vector gradually increases in a period when the electrocardiographic waveform does not contain artifacts. On the other hand, as shown in FIG. 3 (b), the norm of a weight vector increases sharply in a period when the electrocardiographic waveform contains outliers, for example, artifacts.

The determination unit 50 determines whether an outlier is included in the observed signal f(t) in accordance with at least one of the norms calculated by the norm calculation unit 40. For example, the determination unit 50 determines that an outlier is included in the observed signal f(t) when the norm or the amount of change in norms calculated by the norm calculation unit 40 exceeds a predetermined threshold value a predetermined number of times or more. Alternatively, the determination unit 50 determines that an outlier is included in the observed signal f (t) when a moving average of norms shown in FIG. 2(b) exceeds a predetermined threshold value a predetermined number of times or more.

When it is determined that an outlier is included in the observed signal f(t), the outlier detection device 1 may output an image, video, audio, or a combination thereof indicating that an outlier is included in the observed signal f(t).

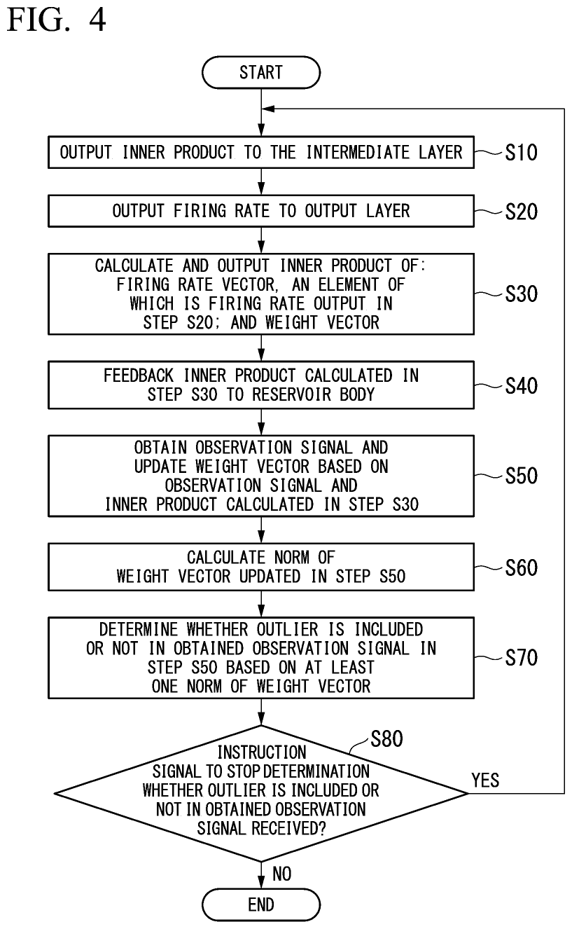

Next, processing executed by the outlier detection device 1 according to an embodiment will be described with reference to FIG. 4. FIG. 4 is a diagram for describing an example of processing executed by an outlier detection device according to the embodiment.

In step S10, the input layer 11 outputs an inner product, for example, the inner product z(t−Δt) described above, to the reservoir main unit 12.

In step S20, the reservoir main unit 12 outputs an activity value, for example, the activity value r₁(t), the activity value r₂(t), . . . , and the activity value rₙ(t) shown in FIG. 1 to the read-out 13.

In step S30, the read-out 13 calculates and outputs an inner product of a weight vector and an activity value vector having, as elements thereof, an activity value output in step S20. For example, the read-out 13 outputs the inner product z(t) of the activity value vector represented by Equation (5) described above and the weight vector represented by Equation (4) described above.

In step S40, the feedback unit 20 feeds back the inner product calculated in step S30, for example, the inner product z(t), to the reservoir main unit 12.

In step S50, the learning unit 30 acquires an observed signal, for example, an observed signal f(t), and updates a weight vector in accordance with the observed signal and the inner product calculated in step S30, for example, the inner product z(t).

In step S60, the norm calculation unit 40 calculates the norm of the weight vector updated in step S50.

In step S70, the determination unit 50 determines whether an outlier is included in the observed signal f(t) acquired in step S50 in accordance with at least one norm of the weight vector.

In step S80, the outlier detection device 1 determines whether it has received a signal instructing to end determination on whether an outlier is included in an observed signal, for example, the observed signal f(t). When the outlier detection device 1 determines that the signal has been received (YES in step S80), the processing returns to step S10, and when it is determined that the signal has not been received (NO in step S80), the processing ends.

The outlier detection device 1 according to the embodiment has been described above. The outlier detection device 1 includes a reservoir computer 10 that calculates and outputs an inner product of an activity value vector having, as elements thereof, an activity value output by each of a plurality of norms connected to each other by synapses, a learning unit 30 that calculates an error between the inner product and an observed signal and updates a weight vector using a value obtained by applying an adaptive filter to the error, a norm calculation unit 40 that sequentially calculates a norm of the updated weight vector, and a determination unit 50 that determines whether an outlier is included in an observed signal on the basis of at least one of the calculated norms.

That is, the outlier detection device 1 determines whether an outlier is included in the observed signal in accordance with the norm of a weight vector instead of pattern matching in a time region or a frequency region. In addition, a dimension of the weight vector described above is smaller than a dimension of a waveform vector used in pattern matching in the time region or the frequency region. Moreover, the FORCE learning method executed by the reservoir computer 10 is a preferred learning method for implementation as digital hardware. Therefore, the outlier detection device 1 can be realized by hardware. For example, the outlier detection device 1 can be efficiently implemented as digital hardware using a Digital Signal Processor (DSP) and a Field-Programmable Gate Array (FPGA). Furthermore, since the outlier detection device 1 continues to update a weight vector while acquiring an observed signal one by one, it has an advantage that it does not need to input and learn an observed signal in advance.

Further, since the learning unit 30 applies an adaptive filter to the error between the inner product z(t) and the observed signal f(t) using the systolic array, the processing of applying the adaptive filter to the error can be efficiently executed.

The determination unit 50 may further determine whether a norm sequentially calculated by the norm calculation unit 40 exceeds a predetermined threshold value. When it is determined that a norm sequentially calculated by the norm calculation unit 40 exceeds a predetermined threshold value, the norm calculation unit 40 may subtract a predetermined value from the sequentially calculated norm. As a result, the outlier detection device 1 can avoid a situation in which a norm calculated by the norm calculation unit 40 becomes too large and accuracy of the determination by the determination unit 50 deteriorates.

In addition, the processing may also be executed by causing a computer-readable recording medium to record a program for realizing each component or some of these components of the outlier detection device 1 according to the embodiment described above, and causing a computer system to read and execute a program recorded in this recording medium.

The computer system herein may include, for example, an operating system (OS) and hardware such as peripheral devices. In addition, the computer-readable recording medium is, for example, a portable medium or a storage device. The portable medium is, for example, a floppy disk, a magneto-optical disc, a read only memory (ROM), a writable non-volatile memory such as a flash memory, or a digital versatile disc (DVD). The storage device is, for example, a hard disk built in a computer system. Furthermore, the computer-readable recording medium may be a volatile memory inside a computer system that serves as a server or a client when a program is transmitted via a network or a communication line.

Moreover, the program described above may be transmitted from a computer system in which this program is stored in a storage device or the like to another computer system via a transmission medium or by transmission waves in the transmission medium. Here, the transmission medium for transmitting the program is a medium having a function of transmitting information like a network such as the Internet or a communication line such as a telephone line.

In addition, the program described above may be for realizing some of the functions described the above, and may also be a program that can realize the functions described the above in combination with a program already recorded in the computer system, a so-called difference program. The program described the above is read and executed by, for example, a processor such as a central processing unit (CPU) included in a computer.

Although the embodiment, the second embodiment, and the third embodiment of the present invention have been described in detail with reference to the drawings, a specific configuration is not limited to these three embodiments, and various modifications and substitutions can be made within a range not departing from the gist of the present invention. The configurations described in each of the embodiments described above may be combined.

### REFERENCE SIGNS LIST

1 Outlier detection device
10 Reservoir computer
11 Input layer
12 Reservoir main unit
13 Read-out
20 Feedback unit
30 Learning unit
40 Norm calculation unit
50 Determination unit
1000 Observed signal receiver

1. An outlier detection device comprising:
a reservoir computer which includes an input layer, a reservoir main unit including a plurality of neurons connected to each other by synapses, and a read-out that is configured to calculate and output an inner product of a weight vector and an activity value vector, each element of which is an activity value output from each of the plurality of neurons on a basis of an input to the input layer;
a learning unit configured to acquire an observed signal, calculate an error between the inner product and the observed signal, and update the weight vector using a value obtained by applying an adaptive filter to the error;
a norm calculation unit configured to sequentially calculate a norm of the weight vector updated by the learning unit; and
a determination unit configured to determine whether an outlier is included in the observed signal on a basis of at least one of the norms calculated by the norm calculation unit.

2. The outlier detection device according to claim 1,
wherein the determination unit is configured to determine whether the norm sequentially calculated by the norm calculation unit exceeds a predetermined threshold value, and
the norm calculation unit is configured to subtract a predetermined value from the sequentially calculated norm when it is determined that the norm sequentially calculated by the norm calculation unit exceeds a predetermined threshold value.

3. The outlier detection device according to claim 1,
wherein the learning unit is configured to use a systolic array when the adaptive filter is applied to calculate an update value on a basis of the error.

4. An outlier detection method comprising:
a reservoir computing step of outputting an inner product of a weight vector and an activity value vector, each element of which is an activity value output by each of a plurality of neurons connected to each other by synapses on a basis of an input to an input layer;
a learning step of acquiring an observed signal, calculating an error between the inner product and the observed signal, and updating the weight vector using a value obtained by applying an adaptive filter to the error;
a norm calculation step of sequentially calculating a norm of the weight vector updated in the learning step; and
a determination step of determining whether an outlier is included in the observed signal on a basis of at least one of the norms calculated in the norm calculation step.

5. An outlier detection program causing a computer to execute:
a reservoir computing function of having an input layer, a reservoir main unit including a plurality of neurons connected to each other by synapses, and a read-out for outputting an inner product of a weight vector and an activity value vector, each element of which is an activity value output from each of the plurality of neurons on a basis of an input to the input layer;
a learning function of acquiring an observed signal, calculating an error between the inner product and the observed signal, and updating the weight vector using a value obtained by applying an adaptive filter to the error;
a norm calculation function of sequentially calculating a norm of the weight vector updated in the learning function; and
a determination function of determining whether an outlier is included in the observed signal on a basis of at least one of the norms calculated in the norm calculation function.

6. The outlier detection device according to claim 2,
wherein the learning unit is configured to use a systolic array when the adaptive filter is applied to calculate an update value on a basis of the error.
